(19) United States
(12) Patent Application Publication
(10) Pub. No.: US 2002/0095499 A1
(43) Pub. Date: Jul. 18, 2002

(54) Delegated administration of information in a database directory using attribute permissions

(75) Inventors: Janet Arlie Barnett, Pattersonville, NY (US); Barbara Jean Vivier, Niskayuna, NY (US); Kareem Sherif Aggour, Schenectady, NY (US); Mark Mithchell Kornfein, Latham, NY (US); Osman Rifki Oksoy, Clifton Park, NY (US); Bassel Omari Williams, Albany, NY (US); Jose Sebastian, Waukesha, WI (US); David Thomas Mehring, Sussex, WI (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company with cover sheet

(21) Appl. No.: 09/760,999

(22) Filed: Jan. 16, 2001

(51) Int. Cl. G06F 15/173

(52) U.S. Cl. 709/226; 709/223

(57) ABSTRACT

A delegated administrative tool for administrating information in a database directory using attribute permissions. The delegated administrative tool enables an administrator to form administrative domains and sub-domains having user attribute permissions that define administrative operations that an administrator can and cannot perform on a user attribute. Also, the delegated administrative tool enables an administrator to define restricted values for assigning to the user attributes.

### BACKGROUND OF THE INVENTION

This disclosure relates generally to community-based computer services and more particularly to administration of community-based computer services using attribute permissions.

Generally, a community is a group of people who typically share a common interest. With the advent of the Internet and e-commerce, many companies are forming communities through intranets and extranets, for employees, suppliers, partners and clients. The communities make it easier and less expensive for the employees, suppliers, partners and clients to work together. In the context of computer services, these people are known as computer users or simply users. Information on each of the users in the communities is stored in a broad range of directories and databases. The information may comprise items such as the user's name, location, telephone number, organization, login identification, password, etc. Other information may comprise the user's access privileges to resources such as applications and content. The directories may also store information on the physical devices (e.g., personal computers, servers, printers, routers, communication servers, etc.) in the networks that support the communities. Additional information may comprise the services (e.g., operating systems, applications, shared-file systems, print queues, etc.) available to each of the physical devices. All of the above information is generally known as community-based computer services.

The administration (i.e., the creation, maintenance, modification, updating and disabling) of these community-based computer services becomes difficult as the communities grow in size and complexity. In many cases, administration becomes an almost impossible task, unless a community is subdivided into more manageable sub-communities. With the creation of these sub-communities, it becomes desirable to use a team of administrators who share responsibilities for administrating the community by assigning different individuals to administer the sub-communities. This type of administration is referred to as delegated administration.

Currently available administration tools that facilitate delegated administration do have their drawbacks. For instance, these tools do not provide the capability to restrict what types of operations an administrator can perform on the user information. One common example includes allowing an administrator to reset a user's password, but not allowing the administrator to view an existing password. In this example, one type of operation (setting a new password) is allowed while another (viewing the existing password) is not. It is important to provide the minimum allowable permissions (or operations) in order to protect the data as much as possible. Also, the currently available administration tools do not provide the capability to restrict values that an administrator can assign to data fields associated with the user information. For example, there are often data fields within a user directory that are used to store user access permissions (which grant access to web-based applications). Typically, these data field values consist of a list of allowable values (an enumerated list), and only values from that list should be entered. By restricting values to only those within that enumerated list, mistakes and typographic errors can be limited.

Therefore, there is a need for an administration tool that provides the capability to restrict what types of operations an administrator can perform on the user information so that an administrator is constrained in what he or she can do. Also, there is a need for an administration tool that provides the capability to restrict values that an administrator can assign to user information in order to both limit the data values that can be entered, as well as ensure correctness of the data.

### BRIEF SUMMARY OF THE INVENTION

In one embodiment of this disclosure, there is a method, system and computer readable medium that stores instructions for instructing a computer system, to manage a user community. In this embodiment, a set of user attributes are defined for each user in the user community. A permission level for managing each of the user attributes is then identified.

In a second embodiment of this disclosure, there is a system, method and computer readable medium that stores instructions for instructing a computer system, to enable an administrator to control administration of a user community. In this embodiment, user information associated with the user community is provided to an administrator. The administrator is prompted to define a set of user attributes for each user in the user community. The administrator is prompted to identify a permission level for each of the user attributes. The identified permission levels are used to control administration of the user information.

In another embodiment, there is a user community administration tool for managing user information associated with a user community. In the user community administration tool there is a domain definition component that defines the user community into at least one administrative domain. The domain definition component comprises a user group specifying component that specifies at least one arbitrary group of users from the user community and a user attribute definition component that defines a set of permissible user attributes for the at least one arbitrary group of users. An information management component manages the user information associated with the administrative domain in accordance with the permissible user attributes.

In still another embodiment, there is a system for managing user information associated with a user community. This system comprises a database directory that contains a plurality of user information. A user community administration tool manages the plurality of user information in the database directory. The user community administration tool comprises a domain definition component that defines the user community into at least one administrative domain. The domain definition component comprises a user group specifying component that specifies at least one arbitrary group of users from the user community and a user attribute definition component that defines a set of permissible user attributes for the at least one arbitrary group of users. An information management component manages the user information associated with the administrative domain in accordance with the permissible user attributes. A computing unit is configured to serve the user community administration tool and the database directory.

### BRIEF DESCRIPTION OF THE DRAWINGS

FIG. 1 shows a schematic of an example of a user community;

FIG. 2 shows an example of delegated administration of the user community shown in FIG. 1;

FIG. 3 shows a schematic of a general-purpose computer system in which a delegated administration tool that creates user attribute permissions for managing information associated with a user community operates;

FIG. 4 shows a top-level component architecture diagram of the delegated administration tool that creates user attribute permissions for managing information and that operates on the computer system shown in FIG. 3;

FIG. 5 shows an architectural diagram of a system for implementing the delegated administration tool that creates user attribute permissions shown in FIG. 4; and

FIG. 6 shows a flow chart of the acts performed to create an administrative domain having user attribute permissions with the delegated administration tool shown in FIG. 4.

### DETAILED DESCRIPTION OF THE INVENTION

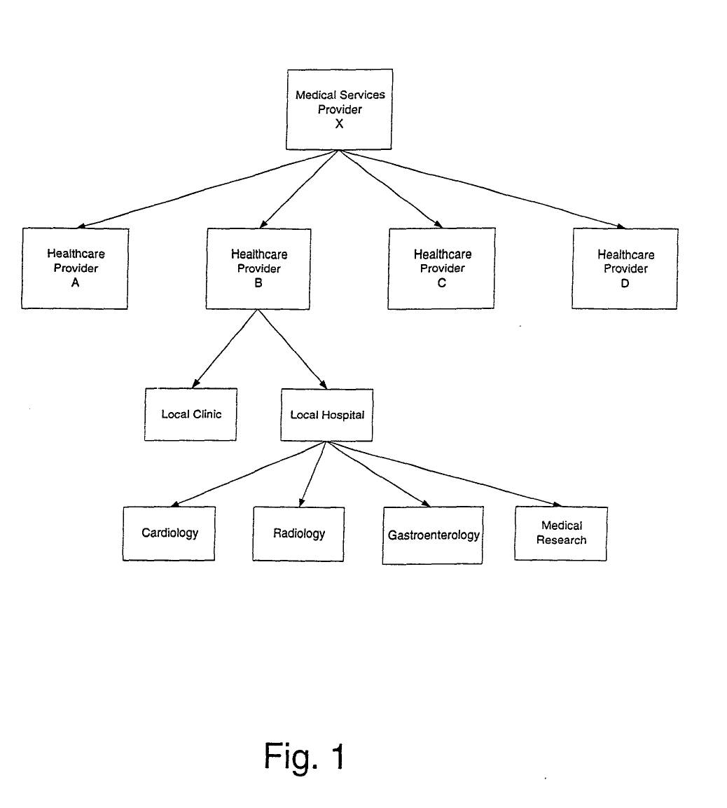

FIG. 1 shows a schematic of an example of a user community receiving a community of services from a medical services provider. The example shown in FIG. 1 is illustrative of the concept of a user community and is not meant to limit this disclosure. In FIG. 1, Healthcare Providers A-D are communities that receive computer-based services from Medical Services Provider X. Examples of such computer-based services may comprise medical information, the ability to order medical supplies, the ability to schedule patient appointments, the ability to file claims for patient services. Other illustrative examples of computer-based services for this scenario may comprise benchmarking information, healthcare statistics and access to downloadable software. The healthcare providers may also want to provide the computer-based services to their clients, partners, vendors, suppliers, etc. In FIG. 1, Healthcare Provider B provides the computer-based services established from Medical Services Provider X to a Local Clinic and Local Hospital with which it has a relationship. The computer-based services can also be provided to their employees. In FIG. 1, the computer-based services are provided to the various departments in the Local Hospital such as Cardiology, Radiology, Gastroenterology, Medical Research, etc. Similar types of distribution of the computer-based services can be provided for the other healthcare providers (i.e., Healthcare Providers A, C and D).

Medical Services Provider X stores information on each of the users in the community in a database directory. The information may comprise items such as the user's name, location, telephone number, organization, login identification, password, etc. Other information may comprise the user's access privileges to certain resources provided by Medical Services Provider X such as applications and content. The database directory of Medical Services Provider may also store information on the physical devices (e.g., personal computers, servers, printers, routers, communication servers, etc.) in the networks that support the communities. Additional information stored in the database directory may comprise the services (e.g., operating systems, applications, shared-file systems, print queues, etc.) available to each of the physical devices.

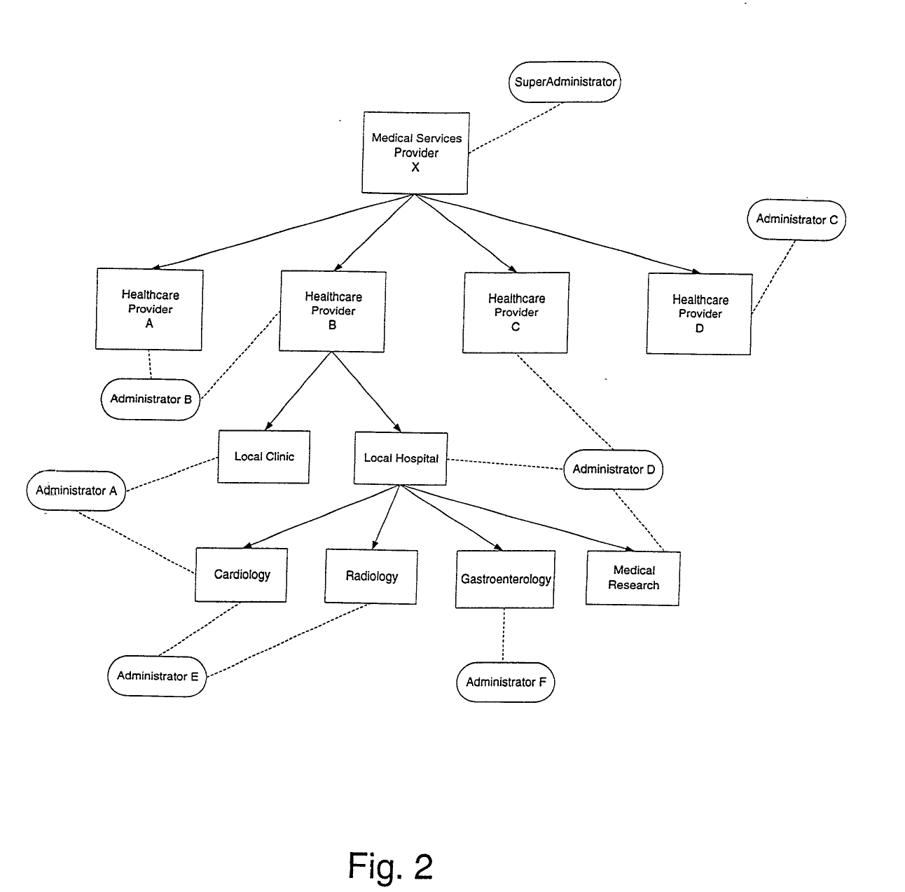

Since the user community shown in FIG. 1 can be quite large and complex, it is desirable to subdivide and delegate administration of these communities. FIG. 2 shows an example of delegated administration of the user community shown in FIG. 1. In this example, there is an administrator for each community that is responsible for managing a variety of activities that include but are not limited to modifying user information, updating permissions to certain resources, disabling user accounts, creating user accounts and maintaining user accounts. For instance, the SuperAdministrator manages the activities for Medical Services Provider X; Administrator A manages the activities for the Local Clinic associated with Healthcare Provider B and the Cardiology department of the Local Hospital; Administrator B manages the activities for Healthcare Providers A and B; Administrator C manages the activities for Healthcare Provider D; Administrator D manages the activities for the Local Hospital associated with Healthcare Provider B, the Medical Research departments for the Local Hospital associated with Healthcare Provider B, as well as the activities for Healthcare Provider C; Administrator E manages the activities for the Cardiology and Radiology departments of the Local Hospital associated with Healthcare Provider B; and Administrator F manages the activities for the Gastroenterology department of the Local Hospital associated with Healthcare Provider B. The extent to which Administrators A-F manage activities depends entirely on the type of authority that they have. Other forms of delegated administration for this example are possible as will be apparent to people skilled in the art.

For purposes of explaining the delegated administration provided with this disclosure, each block (i.e., Medical Services Provider X, Healthcare Providers A-D, Local Clinic, Local Hospital, Cardiology, Radiology, Gastroenterology, Medical Research) in the user community of FIG. 2 represents an administrative domain. An administrative domain is a managed object that comprises a set of users, a set of user attributes which can be modified, and a set of allowable values for those data fields over which an administrator has authority. Possible examples of user attributes may include but are not limited to employer, role or job description, resources that permission has been granted to access, address and equipment used. Generally, an administrator's authority may comprise edit authority and/or delegation authority. An administrator has edit authority within the administrative domain when he or she may edit certain attributes of the users. An administrator has delegation authority within the administrative domain when he or she may define a subset of the users and identify attributes for modification, in order to create an administrative sub-domain. The assignment of the administrative sub-domain to a person is the delegation of that domain. The ability to create an administrative sub-domain and to assign that domain to a user is delegation authority. Although the authority described in this disclosure relates generally to edit authority and delegation authority, one of ordinary skill in the art will recognize that other types of authority such as view, modify, delete, temporary delegation, as well as similar operations, but with limitations on the extent of viewable data, are possible as well. These examples of authority can be used in addition to, in place of, or in combination with the delegation and edit authority.

As mentioned above, it is desirable to be able to create user attribute permissions to restrict what types of operations an administrator can and cannot perform. For example, in FIG. 2, an administrator may only require permission to modify a single data field associated with the user. An example of this could be a company's payroll department; payroll should only be allowed to modify an employee's salary data field.

In addition, it is desirable to be able to restrict values of the user attributes to a subset of allowable values. For example, in FIG. 2, an administrator may be responsible for managing user access to one application. The user directory may contain a data field for defining all applications that the user may access. However, the administrator is only responsible for a single application; consequently, the administrator should only be allowed to set a single value for that application for any user.

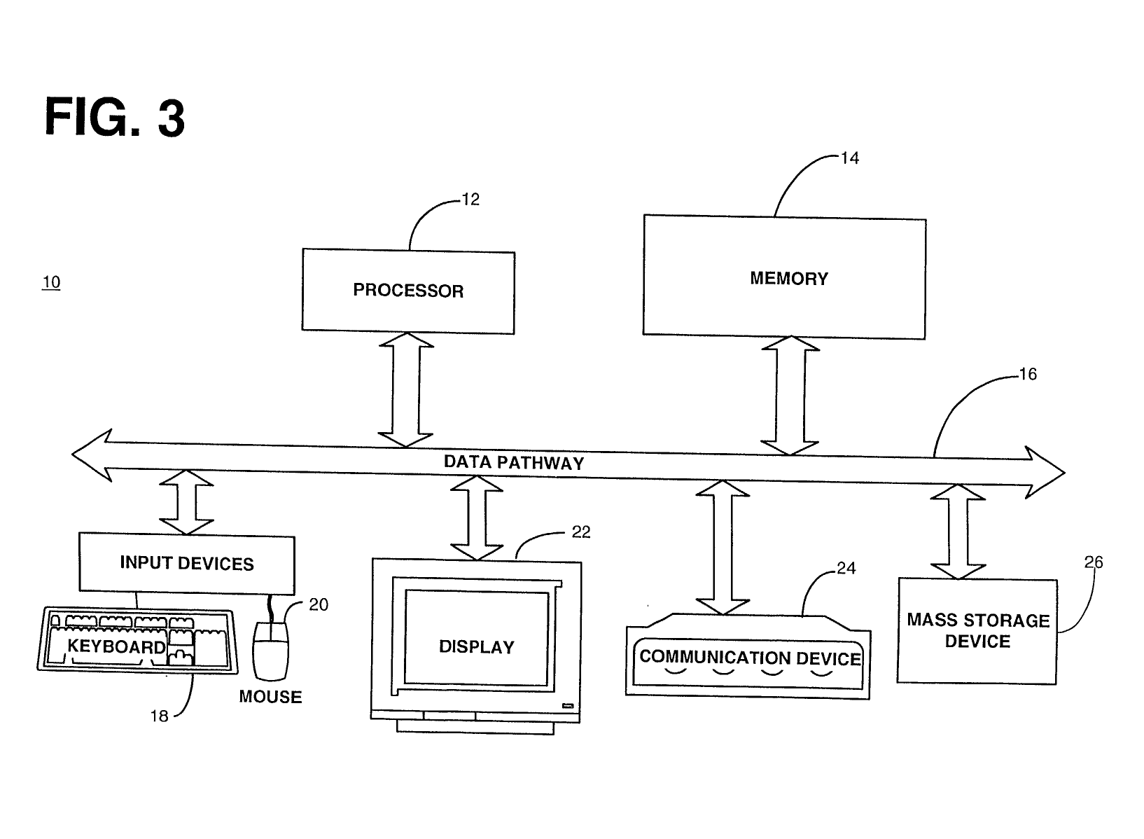

As an example, the above-described delegated administration capabilities for creating user attribute permissions for managing information associated with a user community can be implemented in software. FIG. 3 shows a schematic of a general-purpose computer system 10 in which a delegated administration tool that creates user attribute permissions for managing information operates. The computer system 10 generally comprises at least one processor 12, a memory 14, input/output devices, and data pathways (e.g., buses) 16 connecting the processor, memory and input/output devices. The processor 12 accepts instructions and data from the memory 14 and performs various calculations. The processor 12 includes an arithmetic logic unit (ALU) that performs arithmetic and logical operations and a control unit that extracts instructions from memory 14 and decodes and executes them, calling on the ALU when necessary. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices.

The input/output devices may comprise a keyboard 18 and a mouse 20 that enter data and instructions into the computer system 10. Also, a display 22 may be used to allow a user to see what the computer has accomplished. Other output devices may include a printer, plotter, synthesizer and speakers. A communication device 24 such as a telephone or cable modem or a network card such as an Ethernet adapter, local area network (LAN) adapter, integrated services digital network (ISDN) adapter, or Digital Subscriber Line (DSL) adapter, that enables the computer system 10 to access other computers and resources on a network such as a LAN or a wide area network (WAN). A mass storage device 26 may be used to allow the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, notebook computer, personal computer, workstation, mini-computer, mainframe computer or supercomputer.

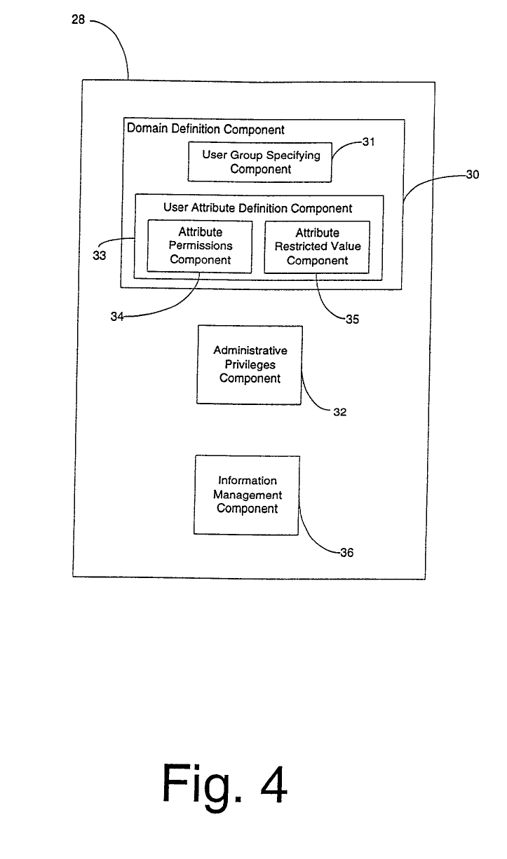

FIG. 4 shows a top-level component architecture diagram of a delegated administration tool 28 that can create user attribute permissions for managing information and that operates on the computer system 10 shown in FIG. 3. The delegated administration tool 28 comprises a domain definition component 30 that defines a user community into at least one administrative domain. The domain definition component 30 comprises a user group specifying component 31 that enables an administrator to specify at least one arbitrary group of users from a user community. The user group specifying component 31 forms the at least one arbitrary group of users through a query rule constructed by the administrator to query a database directory containing user information. The query rule defines the users within the at least one arbitrary group of users. For example, referring to FIG. 2, an administrator can use the user group specifying component 31 to form an administrative domain from one group that comprises users that are radiologists, a second group that comprises users that are employed by Healthcare Provider B, and a third group that comprises users that are located in Wisconsin.

Each arbitrary group of users that is specified has attributes associated with each of its users and allowable values for these attributes. A user attribute definition component 33 enables an administrator to define a set of permissible user attributes for the at least one arbitrary group of users. Specifically, the defined set of permissible user attributes contains the attributes that an administrator can act upon. The user attribute definition component 33 comprises an attribute permission component 34 that enables an administrator to specify a permission level for each of the user attributes. The permission level is associated with management of attributes as defined within a domain. This allows different administrators to have different permissions when managing the same data. In particular, the permission level is indicative of what types of operations can and cannot be performed on the attributes associated with the at least one arbitrary group of users. Some operations that an administrator can perform on user attributes comprise viewing, editing and deleting. These administrative operations are illustrative of only a few operations that can be performed on the attributes and are not exhaustive of other possibilities. Examples of some other administrative operations that can be performed on the attributes are editing during a particular time period and resetting data fields to default values. An administrator can use the attribute permission component 34 to select any of these operations to restrict what can and cannot be done to the attributes. Selection of permissions for the attributes is left to the user that is setting up the administrative domain. It is possible to select just one of the above operations or any combination of the operations.

Referring again to FIG. 2 as example, an administrator can use the attribute permission component 34 for the administrative domain that comprises radiologists that are employed by Healthcare Provider B in the state of Wisconsin to define what types of operations can and cannot be formed on certain attributes. For example, permission to prevent an administrator from editing, viewing and deleting an attribute such as a radiologist's salary can be defined, while permission can be granted to edit and view what type of diagnostic software tools that a radiologist is licensed to use. Another permission that can be defined is to permit an administrator to edit, view, and delete general user information such as the radiologist's name, address, email address, phone number, etc.

The user attribute definition component 33 also comprises an attribute restricted value component 35 that enables an administrator to specify certain values that can be assigned to user attributes. It is possible that some user attributes will have similar restricted values. Also, it is possible to use a set of specified restricted attributes across a multiple of user directories. Referring again to FIG. 2 as an example, an administrator can use the attribute restricted value component 35 for the administrative domain that comprises radiologists that are employed by Healthcare Provider B in the state of Wisconsin to define what values an administrator can assign for a user attribute. For example, for the “State of Employment” user attribute, values can be restricted to one of 50 possible values, wherein the values are limited to two letter abbreviations (e.g., WI, NY, etc.). In another scenario, the attribute restricted value component 35 could be used to restrict values for a user attribute such as “Permissions Authorization”, where an administrator assigns values to different applications. In such a scenario, each administrator may have permission to set values associated with a particular application, but not values associated with other applications. For example, in FIG. 2, the local hospital administrator (Administrator D) may limit what Administrator E may do to only setting Radiology and Cardiology applications permissions for users in the Radiology and Cardiology departments, respectively.

The delegated administration tool 28 also comprises an administrative privileges component 32. The administrative privileges component 32 enables an administrator to grant administrative privileges for an administrative domain or administrative sub-domain that he or she has authority for. The granted administrative privileges may comprise at least one of delegation authority and edit authority. As mentioned above, it is also possible to grant other types of authority such as view, modify, delete, temporary delegation, etc. These examples of authority can be used in addition to, in place of, or in combination with the delegation and edit authority.

The administrative privileges component 32 also enables an administrator to define which users in an administrative domain or sub-domain that he or she operates and has authority for will have the granted administrative privileges. More specifically, an administrator can use this component to define various administrators for their operational domain by assigning delegation authority, edit authority or other types to a particular user. Administrators with delegation authority can also use the domain definition component 30 (i.e., the user group specifying component 31 and user attribute definition component 33) to form sub-domains from an additional group of users for their operational domain and assign certain attribute permissions and values for a subset of user attributes. The administrator can also use the administrative privileges component 32 to grant authority for that particular subdomain that they have defined.

The delegated administration tool 28 also comprises an information management component 36 that manages information associated with each of the administrative domains in accordance with the delegated administrative privileges. Depending on the type of authority delegated and the permission level associated with each of the user attributes, an administrator can use the information management component 36 to perform operations including but not limited to editing, viewing or deleting specific attributes for a user in a domain. The information management component 36 is not limited to these functions and may perform other functions such as generating reports (e.g., reports on all users within a domain), analyzing data (e.g., determining how frequently some types of data change), performing statistical analysis or allowing users to perform self-administration on certain attributes (e.g., phone number, e-mail address, passwords, etc.).

The delegated administration tool 28 is not limited to a software implementation. For instance, the domain definition component 30 (i.e., the user group specifying component 31 and user attribute definition component 33 which includes the attribute permissions component 34 and attribute restricted value component 35), administrative privileges component 32 and information management component 36 may take the form of hardware or firmware or combinations of software, hardware, and firmware.

In addition, the delegated administration tool 28 is not limited to the domain definition component 30 (i.e., the user group specifying component 31 and user attribute definition component 33 which includes the attribute permissions component 34 and attribute restricted value component 35), administrative privileges component 32 and information management component 36. One of ordinary skill in the art will recognize that the delegated administration tool 28 may have other components. For example, the delegated administration tool 28 could also include a workflow component that manages processes surrounding user creation and administration. Also, the delegated administration tool 28 could include a reporting component that reports usage statistics, error conditions, etc. There could also be a transactional management component that performs transactions using 2-phase commit/rollback. Still another component that the delegated administration tool 28 could include is a browsing component for viewing information associated with the hierarchy of administrative domains.

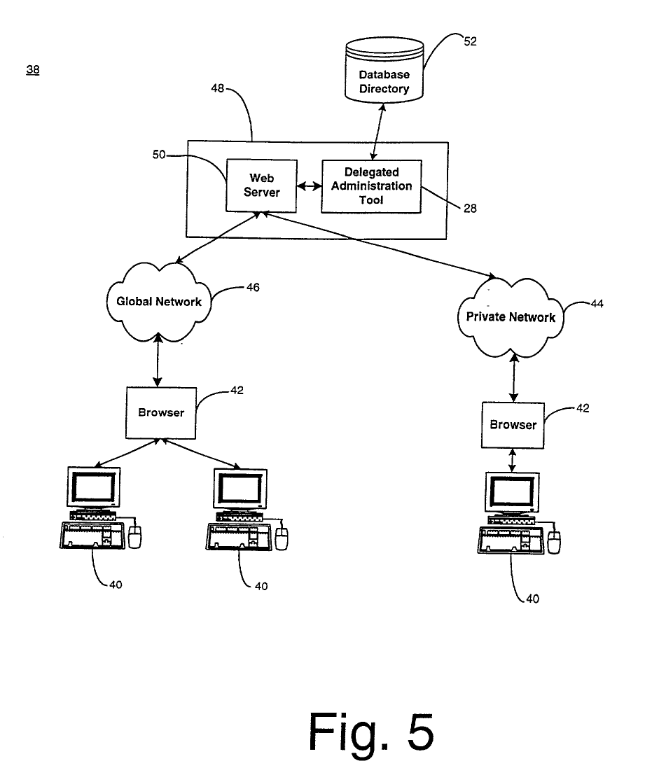

FIG. 5 shows an architectural diagram of a system 38 for implementing the delegated administration tool shown in FIG. 4. FIG. 5 shows that there are several ways of accessing the delegated administration tool 28. A computing unit 40 allows an administrator to access the delegated administration tool 28. The administrator could be the SuperAdministrator or administrators with delegation authority, edit authority or other types of authority. Also, users in the domain may access the delegated administration tool 28 through a computing unit 40 to perform some basic self-administration. The computing unit 40 can take the form of a hand-held digital computer, personal digital assistant computer, notebook computer, personal computer or workstation. The administrators and users use a web browser 42 such as Microsoft INTERNET EXPLORER or Netscape NAVIGATOR to locate and display the delegated administration tool 28 on the computing unit 40. A communication network such as an electronic or wireless network connects the computing unit 40 to the delegated administration tool 28. FIG. 5 shows that the computing units 40 may connect to the delegated administration tool 28 through a private network 44 such as an extranet or intranet or a global network 46 such as a WAN (e.g., Internet). As shown in FIG. 5, the delegated administration tool 28 resides in a server 48, which comprises a web server 50 that serves the delegated administration tool 28 and a database directory 52 (or directories) that contains the various information for the users in all of the domains that form the community. However, the delegated administration tool does not have to be co-resident with the server 48. If desired, the system 38 may have functionality that enables authentication and access control of users accessing the delegated administration tool 28. Both authentication and access control can be handled at the web server level by the delegated administration tool 28 itself, or by commercially available packages such as Netegrity SITEMINDER.

The information in the database directory 52 as mentioned above may comprise information such as the user's name, location, telephone number, organization, login identification, password, etc. Other information may comprise the user's access privileges to certain resources such as applications and content. The database directory 52 may also store information on the physical devices (e.g., personal computers, servers, printers, routers, communication servers, etc.) in the networks that support the communities. Additional information stored in the database directory 52 may comprise the services (e.g., operating systems, applications, shared-file systems, print queues, etc.) available to each of the physical devices. The database directory 52 can take the form of a lightweight directory access protocol (LDAP) database; however, other directory type databases with other types of schema can be used with the delegated administration tool 28, including relational databases, object-oriented databases, flat files, or other data management systems.

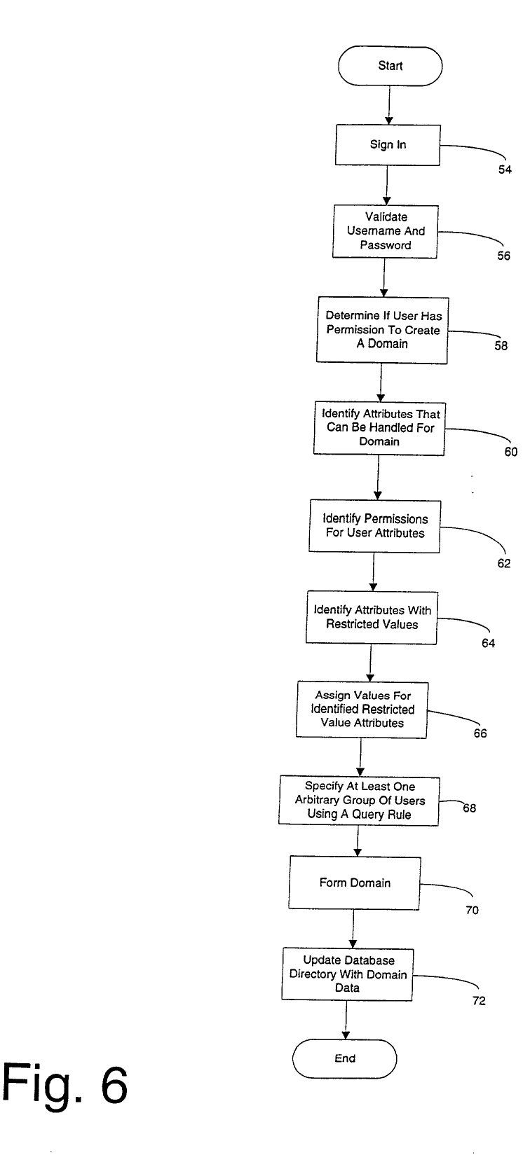

Using the system 38 shown in FIG. 5, an administrator such as a SuperAdministrator or an administrator with delegation or edit authority can use the delegated administration tool 28 to create user attribute permissions. Also, users of the community can use the delegated administration tool 28 to restrict user attribute values to a subset of allowable values. FIG. 6 shows a flow chart describing the acts performed to create an administrative domain having user attribute permissions with the delegated administration tool 28. To create an administrative domain, the user must be either a SuperAdministrator or an administrator having delegation authority. At block 54, the SuperAdministrator or administrator with delegation authority signs in. The sign-in act can include entering identity and security information (e.g., a valid usemame and password). The delegated administration tool validates the username and password at 56. The delegated administration tool then determines if the user has permission (i.e., the user is a SuperAdministrator or administrator with delegation authority) to create an administrative domain at 58. If the user is not authenticated or does not have permission to create an administrative domain, then the user is not allowed to create a domain.

At 60, the user identifies a subset of attributes that can be handled for the administrative domain. As mentioned above, attributes may comprise any data, which describe information about a user (e.g., employer, job description, resources that permission has been granted to access, address, equipment used, etc.). Next, the user identifies permissions that define what type of operations (e.g., edit, view, delete, etc.) an administrator can and cannot perform on each of the attributes in the domain at 62. The user then identifies attributes that will have restricted values associated therewith at 64. The determination of whether an attribute is designated as a restricted value component is left to the discretion of the user. At 66, the user assigns allowable values for the attributes that have been identified to have restricted values. Generally, a list of the restricted value attributes and allowable values for any domain can be created beforehand by a SuperAdministrator. Therefore, when an administrator with delegation authority wants to create an administrative domain, the acts of identifying restricted value attributes and assigning allowable values is performed by making selections from the list created by the SuperAdministrator. For example, consider a “country” attribute that identifies the location of a user. The SuperAdministrator can restrict the “country” attribute to a limited set of country abbreviations. For instance, in order to represent the countries United States, Canada and Mexico, the SuperAdministrator can define a set of values such as USA, CAN or MEX, respectively. Thus, a user that is creating an administrative domain can then select these restricted values to be used with the “country” attribute.

Next, the user specifies at least one arbitrary group of users that can be administered, where each user in the group is characterized by the same attributes that have permissions on how an administrator can manage these attributes. In particular, the at least one arbitrary group of users are specified from the database directory by constructing a query rule at 68. The results of the query define the members of the groups of users in the community or domain. After the query rule has been constructed, the community or domain is formed at 70. Next, the database directory is updated at 72 with the data for the newly created administrative domain. If an administrator with delegation authority wants to create another domain from their operational domain, then blocks 58-72 are repeated. Otherwise, any time a SuperAdministrator or an administrator with delegation authority desires to create an administrative domain for their operational domain, then blocks 54 through 72 are repeated.

The foregoing flow charts of this disclosure show the functionality and operation of the delegated administration tool. In this regard, each block represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Also, one of ordinary skill in the art will recognize that additional blocks may be added. Furthermore, the functions can be implemented in programming languages such as C++ or JAVA; however, other languages can be used.

The above-described delegated administration tool comprises an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided in accordance with this invention, a delegated administration tool. While the invention has been particularly shown and described in conjunction with a preferred embodiment thereof, it will be appreciated that variations and modifications can be effected by a person of ordinary skill in the art without departing from the scope of the invention.

What is claimed is:

1. A method for managing a user community, comprising:
defining a set of user attributes for each user in the user community; and
identifying a permission level for managing each of the user attributes.

2. The method according to claim 1, wherein each permission level defines administrative operations that an administrator can and cannot perform on a user attribute.

3. The method according to claim 1, further comprising defining restricted values that an administrator can assign for the user attributes.

4. A method for managing user information associated with a user community, comprising:
defining a set of user attributes from the user information for each user the user community;
identifying a permission level for each of the user attributes; and
managing the user attributes according to each of the permission levels.

5. The method according to claim 4, wherein each permission level defines operations that an administrator can and cannot be perform on a user attribute.

6. The method according to claim 4, further comprising defining restricted values that an administrator can assign for any of the user attributes.

7. A method for enabling an administrator to control administration of a user community, comprising:
providing user information associated with the user community to the administrator;
prompting the administrator to define a set of user attributes for each user in the user community;
prompting the administrator to identify a permission level for each of the user attributes; and
using the identified permission levels to control administration of the user information.

8. The method according to claim 7, wherein each permission level defines operations that the administrator can and cannot perform on a user attribute.

9. The method according to claim 8, further comprising prompting the administrator to define restricted values that the administrator can assign for any of the user attributes.

10. A user community administration tool for managing user information associated with a user community, comprising:
a domain definition component that defines the user community into at least one administrative domain, the domain definition component comprising a user group specifying component that specifies at least one arbitrary group of users from the user community and a user attribute definition component that defines a set of permissible user attributes for the at least one arbitrary group of users; and
an information management component that manages the user information associated with the administrative domain in accordance with the permissible user attributes.

11. The tool according to claim 10, wherein the user attribute definition component comprises an attribute permission component that specifies a permission level for each of the user attributes.

12. The tool according to claim 11, wherein each permission level defines operations that an administrator can and cannot perform on a user attribute.

13. The tool according to claim 10, wherein the user attribute definition component comprises an attribute restricted value component that defines restricted values that an administrator can assign for any of the user attributes.

14. The tool according to claim 10, further comprising an administrative privileges component that grants administrative privileges for the administrative domain.

15. The tool according to claim 14, wherein the administrative privileges component delegates the granted administrative privileges for the administrative domain.

16. A system for managing user information associated with a user community, comprising:
a database directory containing a plurality of user information;
a user community administration tool to manage the plurality of user information in the database directory; the user community administration tool comprising a domain definition component that defines the user community into at least one administrative domain, the domain definition component comprising a user group specifying component that specifies at least one arbitrary group of users from the user community and a user attribute definition component that defines a set of permissible user attributes for the at least one arbitrary group of users; and an information management component that manages the user information associated with the administrative domain in accordance with the permissible user attributes; and
a first computing unit configured to serve the user community administration tool and the database directory.

17. The system according to claim 16, further comprising a second computing unit configured to execute the user community administration tool served from the first computing unit over a network.

18. The system according to claim 16, wherein the user attribute definition component comprises an attribute permission component that specifies a permission level for each of the user attributes.

19. The system according to claim 18, wherein each permission level defines operations that an administrator can and cannot perform on a user attribute.

20. The system according to claim 16, wherein the user attribute definition component comprises an attribute restricted value component that defines restricted values that an administrator can assign for any of the user attributes.

21. A user community administration tool for providing administration of a user community, comprising:
means for defining the user community into at least one administrative domain, the administrative domain definition means comprising means for specifying at least one arbitrary group of users from the user community and means for defining a set of permissible user attributes for the at least one arbitrary group of users; and
means for managing the user information associated with the administrative domain in accordance with the permissible user attributes.

22. The tool according to claim 21, wherein the user attribute definition means comprises means for specifying a permission level for each of the user attributes.

23. The tool according to claim 22, wherein each permission level defines operations that an administrator can and cannot perform on a user attribute.

24. The tool according to claim 21, wherein the user attribute definition means comprises means for defining restricted values that an administrator can assign for any of the user attributes.

25. A computer-readable medium storing computer instructions for instructing a computer system to manage a user community, the computer instructions comprising:
defining a set of user attributes for each user in the user community; and
identifying a permission level for managing each of the user attributes.

26. The computer-readable medium according to claim 25, wherein each permission level defines operations that an administrator can and cannot perform on a user attribute.

27. The computer-readable medium according to claim 25, further comprising instructions for defining restricted values that an administrator can assign for any of the user attributes.

28. A computer-readable medium storing computer instructions for instructing a computer system to enable an administrator to control administration of a user community, the computer instructions comprising:
providing user information associated with the user community to the administrator;
prompting the administrator to define a set of user attributes for each of the users in the user community;
prompting the administrator to identify a permission level for each of the user attributes; and
using the identified permission levels to control administration of the user information.

29. The computer-readable medium according to claim 28, wherein each permission level defines operations that the administrator can and cannot perform on a user attribute.

30. The computer-readable medium according to claim 28, further comprising instructions for prompting the administrator to define restricted values that the administrator can assign for any of the user attributes.
